(19) United States
(12) Patent Application Publication
(10) Pub. No.: US 2014/0093775 A1
(43) Pub. Date: Apr. 3, 2014

(54) ACTIVE MATERIAL COMPOSITIONS COMPRISING HIGH SURFACE AREA CARBONACEOUS MATERIALS

(71) Applicant: CABOT CORPORATION, BOSTON, MA (US)

(72) Inventors: Ned J. Hardman, Albuquerque, NM (US); Paolina Atanassova, Albuquerque, NM (US); Miodrag Oljaca, Billerica, MA (US); Berislav Blizanac, Billerica, MA (US); Kenneth C. Koehlert, Billerica, MA (US); Aurelien L. DuPasquier, Billerica, MA (US)

(73) Assignee: CABOT CORPORATION, BOSTON, MA (US)

(21) Appl. No.: 14/039,297

(22) Filed: Sep. 27, 2013

Related U.S. Application Data
(60) Provisional application No. 61/707,155, filed on Sep. 28, 2012.

(51) Int. Cl. H01M 4/583; H01M 4/04

(52) U.S. Cl. CPC H01M 4/583; H01M 4/0416
USPC 429/215; 252/182.1; 427/122

(57) ABSTRACT

Disclosed herein are negative active material compositions, comprising: a carbonaceous material having a surface area of at least 250 m²/g; and an organic molecule expander, wherein the ratio of carbonaceous material to expander ranges from 5:1 to 1:1, and wherein the composition has a median pore size ranging from 0.8 μm to 4 μm. Also disclosed are electrodes and batteries comprising such compositions, and methods of making thereof.

### RELATED APPLICATION

This application claims priority under 35 U.S.C. §119(e) to U.S. Provisional App. 61/707,155, filed Sep. 28, 2012, the disclosure of which is incorporated herein by reference.

### FIELD OF THE INVENTION

Disclosed herein are negative active material compositions comprising high surface area carbonaceous materials, which can be used as electrode materials in lead acid batteries.

### BACKGROUND

There is a continual need to improve the performance of lead acid batteries. Metrics for battery performance include cycle life, dynamic charge acceptance (DCA), water loss, and cold crank ability. Cold crank ability can be measured as “cold crank time” and is determined as follows: after reducing the battery temperature to −18° C. for 24 hours, the battery is then discharged at a high rate (5-14 C). The time necessary for the battery voltage to decrease from the initial 14.4 V to 6V is defined as the cold crank time. Due to the ever widening applications for lead acid batteries, there remains a need to improve battery performance, including improving DCA and cycle life while maintaining or improving cold crank ability and/or decreasing water loss.

### SUMMARY

One embodiment provides a negative active material composition, comprising:

a carbonaceous material having a surface area of at least 250 m²/g; and

an organic molecule expander,

wherein the ratio of carbonaceous material to expander ranges from 5:1 to 1:1, and

wherein the composition has a median pore size ranging from 0.8 μm to 4 μm.

Another embodiment provides a method of making a negative active material composition for a lead acid battery, comprising:

combining a lead oxide, an organic molecule expander, and BaSO₄ to form a dry powder mixture;

combining the dry powder mixture with water, to which sulfuric acid is subsequently added, to form a slurry;

adding to the slurry a carbonaceous material having a surface area of at least 250 m²/g, and

forming a paste intermediate of the negative active material composition.

Another embodiment provides a method of making a negative active material composition for a lead acid battery, comprising:

combining a lead oxide, an organic molecule expander, and BaSO₄ to form a dry powder mixture;

adding a pre-wetted carbonaceous material having a surface area of at least 250 m²/g to the dry powder mixture;

combining sulfuric acid and water with the mixture containing the carbonaceous material to form a slurry; and

forming a paste intermediate of the negative active material composition.

### BRIEF DESCRIPTION OF THE DRAWING(S)

FIG. 1A (prior art) schematically illustrates the structure of a surface of a lead-containing species for a NAM material;

FIG. 1B schematically illustrates the structure of a surface of a lead-containing species for the negative active material compositions as disclosed herein; and

FIG. 2 is a graph depicting the correlation of mixing method of carbonaceous material with lignosulfonate and amount of carbonaceous material (x-axis, wt. %) with pore size (y-axis, median pore radius (volume, μm)).

### DETAILED DESCRIPTION

Disclosed herein are new negative active material compositions (e.g. negative active mass or NAM), which can be used in electrodes for lead acid batteries.

Upon discharging a lead acid battery, a smooth PbSO₄ layer may form on the negative lead electrode. This layer passivates the electrode by blocking the release of Pb²⁺ ions necessary for current flow, resulting in a reduction in battery capacity and power output. The problem can be alleviated by the addition of expanders (e.g., organic molecules such as lignosulfonate) that can retard PbSO₄ film growth by adsorbing onto and coating the lead surface. The lignosulfonate promotes formation of a porous PbSO₄ solid and prevents growth of a smooth PbSO₄ layer. Additionally, if lignosulfonate is not present at the lead surface during curing and formation, the lead can sinter to form a non-porous/low porosity monolith, which results in low cold crank ability.

Carbon materials are also typically added to the expander composition to improve conductivity, crystallite growth control, and electron transfer processes at the NAM-charge and discharge can also occur at the carbon surface. However, the lignosulfonate has a tendency to coat the carbon surface, reducing its availability for coating the lead surface that helps prevent the formation of the PbSO₄ passivating layer. Moreover, small particle carbon can fill in the pores of the composition resulting in reduced median pore size.

Controlling water loss is another consideration in the design of low-maintenance or maintenance-free lead acid batteries. Water loss in lead acid batteries occurs during charge and over-charge, and is due to evolution of hydrogen on the negative plate and oxygen evolution on the positive plate. The water loss in lead acid batteries is affected by the positive and negative plate potentials during charge, and can be influenced by the presence of certain metal impurities in the acid electrolyte, grids and electrode components. The addition of carbon in the negative plates leads to increased water loss, which depends on the amount and type of carbon (surface area and morphology). A relationship between electrode surface area and negative plate potential can be illustrated with the Butler-Vollmer for hydrogen reduction, shown as equation (1) below:

I=−A·i₀·exp[−α_{c}nF/RT(E−E_{eq})] (1)

where, I=cathodic current; A=electrode surface area; E=negative plate potential.

While the exact mechanism of the effect of carbon on water loss in lead acid batteries is still under investigation, from equation (1) it is a likely effect that the addition of carbon to the negative plate can lead to increased surface area of the negative electrode and therefore to the depolarization of the negative electrode. The depolarization of the negative electrode can then lead to lower values in the electrode potential and therefore can increase the hydrogen evolution rates both from lead and carbon surfaces. The depolarization of the negative plate can lead to polarization of the positive plate and therefore increased oxygen evolution rates on the positive electrode. Both increased hydrogen evolution on the negative electrode and increased oxygen evolution on the positive plate can contribute to increased water loss.

One embodiment provides a negative active material comprising high surface area carbonaceous materials, resulting in improved DCA and cycle life. However, high surface area carbonaceous materials can deleteriously reduce the cold crank ability and/or increased water loss on overcharge. In one embodiment, it has been discovered that increasing the expander concentration and/or increasing the porosity of the negative active materials improves the cold crank ability and/or decreases the amount of water loss. The embodiments disclosed herein can allow incorporation of the high surface area carbonaceous materials to exploit its other advantages. Accordingly, one embodiment provides a negative active material composition comprising:

a carbonaceous material having a surface area of at least 250 m²/g; and

an organic molecule expander,

wherein the ratio of carbonaceous material to expander ranges from 5:1 to 1:1, and

wherein the composition has a median pore size ranging from 0.8 μm to 4 μm.

In one embodiment, the carbonaceous material is selected from carbon black, activated carbon, expanded graphite, graphene, few layer graphene, carbon nanotubes, carbon fibers, carbon nanofibers, graphite and any milled, crushed, or otherwise processed version of the former. In one embodiment, the carbonaceous material is carbon black. “Carbon black” includes all forms of the material such as lamp black, furnace black, acetylene black, channel black, etc.

“Organic molecule expander” as defined herein is a molecule capable of adsorbing or covalently bonding to the surface of a lead-containing species to form a porous network that prevents or substantially decreases the rate of formation of a smooth layer of PbSO₄ at the surface of the lead-containing species. In one embodiment, the organic molecule expander has a molecular weight greater than 300 g/mol. Exemplary organic molecule expanders include lignosulfonates, lignins, wood flour, pulp, humic acid, and wood products, and derivatives or decomposition products thereof. In one embodiment, the expander is selected from lignosulfonates, a molecule having a substantial portion that contains a lignin structure. Lignins are polymeric species comprising primarily phenyl propane groups with some number of methoxy, phenolic, sulfur (organic and inorganic), and carboxylic acid groups. Typically, lignosulfonates are lignin molecules that have been sulfonated. Typical lignosulfonates include the Borregard Lignotech products UP-393, UP-413, UP-414, UP-416, UP-417, M, D, VS-A (Vanisperse A), and the like. Other useful exemplary lignosulfonates are listed in, “Lead Acid Batteries”, Pavlov, Elsevier Publishing, 2011, the disclosure of which is incorporated herein by reference.

In another embodiment, the carbonaceous material has a surface area (BET) ranging from 250 m²/g to 2100 m²/g, such as surface area ranging from 400 m²/g to 1800 m²/g, from 700 m²/g to 1700 m²/g, from 1000 m²/g to 2600 m²/g, or from 1000 m²/g to 1700 m²/g.

In another embodiment, the structure of the carbonaceous material can be measured by DBP. In one embodiment, the DBP for these materials can range from 32 mL/100 g to 500 mL/100 g, such as a DBP ranging from 80 to 350 mL/100 g, or from 110 to 250 mL/100 g.

Current lead acid batteries employ low surface area carbon blacks that can achieve acceptable cold crank times. In an attempt to improve DCA and cycle life, a higher surface area carbon black was incorporated using the standard prior art configuration. However, because the expander has a tendency to adhere to the carbon black, it was discovered that less expander was available for the surface of the lead-containing species due to competing adsorption with the higher surface area carbon black. Subsequently there was a lesser amount of expander film on the lead-containing surface to counteract passive PbSO₄ film formation, and the resulting PbSO₄ film formed upon discharge exhibited lower median pore sizes (or smooth film formation) thereby preventing the release of Pb²⁺. As a result, cold crank times would deleteriously decrease by as much as 50-70% compared to the value achieved by the standard battery. It has been discovered that the negative active material compositions disclosed herein can incorporate high surface area carbon blacks by allowing a greater amount of expander to adhere to the lead-containing surface (as opposed to the carbon surface), thereby causing porous PbSO₄ film formation. Batteries incorporating the materials disclosed herein achieve cold crank times comparable with that of the standard battery while exhibiting improved DCA and cycle life.

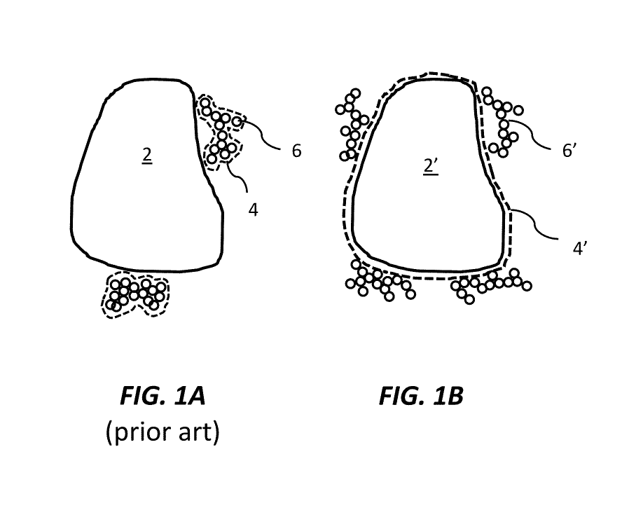

Without wishing to be bound by any theory, FIGS. 1A and 1B schematically illustrate the structure of a surface of a lead-containing species (e.g., Pb/PbO/PbSO₄) for a NAM material incorporating a high surface area carbonaceous material (FIG. 1A) having the prior art configuration, and for the composition as disclosed herein (FIG. 1B). In FIGS. 1A and 1B, adhered onto lead-containing surfaces 2 and 2′, respectively, are organic molecule expander 4 and 4′ (dashed lines) and carbonaceous materials 6 and 6′. However, in FIG. 1A, a significant portion of the expander 4 coats the carbonaceous material 6, leaving a substantial portion of the lead-containing surface 2 uncoated by the expander 4, rendering the surface vulnerable to growth of a smooth PbSO₄ layer of low or no porosity.

In one embodiment, the disclosed materials are prepared in such a way as to incorporate the high surface area carbonaceous materials 6′ such that a significant portion of the expander 4′ is available to coat the lead-containing surface 2′, preventing growth of the passivating layer of PbSO₄ upon rapid discharge. In another embodiment, the presence of a higher concentration of expander 4′ can allow an increased portion of the lead-containing surface 2′ to be coated by the expander 4′. Additionally, the composition has sufficient median pore size in the presence of a high external surface area carbonaceous material. Typically, the presence of a high external surface area carbonaceous material will result in a less porous electrode that possesses a median pore size of less than 1.0 μm or less than 1.5 μm, as measured by mercury porosimetry. In one embodiment, at least 20% of the organic molecule expander in the composition coats a surface of the lead-containing species. In another embodiment, at least 30%, at least 40%, or at least 50% of the expander in the composition coats a surface of the lead-containing species.

In one embodiment, the negative active material has a median pore size sufficient to achieve acceptable cold crank ability. Although a layer of the organic molecule expander promotes porosity of the negative active material, PbSO₄ particles can also hinder release of Pb²⁺ by blocking the pores. Thus, the presence of larger pores will avoid blockage by PbSO₄ particles. Accordingly, the negative active materials disclosed herein has a median pore size ranging from 0.8 μm to 4 μm, from 0.8 μm to 3.5 μm, or from 0.8 μm to 3.5 μm, such as a median pore size ranging from 1.2 μm to 4 μm, from 1.2 μm to 3.5 μm, from 1.2 μm to 3 μm, from 1.5 μm to 4 μm, from 1.5 μm to 3.5 μm, from 1.5 μm to 3 μm, from 1.8 μm to 4 μm, from 1.8 μm to 3.5 μm, or from 1.8 μm to 3 μm.

In one embodiment, the use of high surface area carbonaceous materials allows the formation of high surface area (BET) negative active materials. In one embodiment, the composition has a surface area of greater than 3.0 m²/g, such as a surface area of greater than 5.0 m²/g. In another embodiment, the composition has a surface area ranging from 3.0 m²/g to 20 m²/g, such as surface areas ranging from 3.0 m²/g to 12 m²/g, from 3.0 m²/g to 10 m²/g, from 5.0 m²/g to 20 m²/g, from 5.0 m²/g to 12 m²/g, or from 5.0 m²/g to 10 m²/g. In one embodiment, the composition has a surface area of greater than 3.0 m²/g (and up to 20 m²/g, 12 m²/g, or 10 m²/g) and a median pore size ranging from 1.0 μm to 3.5 μm. In another embodiment, the composition has a surface area of greater than 5.0 m²/g (and up to 20 m²/g, 12 m²/g, or 10 m²/g) and a median pore size ranging from 1.5 μm to 3.5 μm.

In one embodiment, the negative active material further comprises a lead-containing material and BaSO₄. In one embodiment, the lead-containing material is selected from lead, PbO, Pb₃O₄, Pb₂O, and PbSO₄, hydroxides thereof, acids thereof, and other polymetallic lead complexes thereof. A source of the lead-containing material can be leady oxide, which comprises primarily PbO and lead. During manufacture of the negative active material, PbSO₄ is generated in a reaction between the leady oxide and H₂SO₄.

In another embodiment, it has been discovered that the amount of carbonaceous material and/or the organic molecule expander can affect the pore size. In one embodiment, the ratio of carbonaceous material to expander ranges from 5:1 to 1:1, e.g., from 4:1 to 1:1 or from 3:1 to 1:1. In another embodiment, the carbonaceous material is present in an amount ranging from 0.05% to 3% by weight and the organic molecule expander is present in an amount ranging from 0.05% to 1.5% by weight, from 0.2% to 1.5% by weight, or from 0.3% to 1.5% by weight, relative to the total weight of the composition. In one embodiment, the carbonaceous material is present in an amount ranging from 0.15% to 3% by weight relative to the total weight of the composition, e.g., in an amount ranging from 0.15% to 2% by weight, from 0.15% to 1.2% by weight, from 0.15% to 1% by weight, from 0.25% to 3% by weight, from 0.25% to 2% by weight, from 0.25% to 1.5% by weight, from 0.25% to 1.2% by weight, from 0.25% to 1% by weight, from 0.4% to 3% by weight, from 0.4% to 2% by weight, from 0.4% to 1.5% by weight, from 0.4% to 1.2% by weight, from 0.4% to 1% by weight, from 0.5% to 3% by weight, from 0.5% to 2% by weight, from 0.5% to 1.5% by weight, from 0.5% to 1.2% by weight, from 0.5% to 1% by weight, from 0.6% to 3% by weight, from 0.6% to 2% by weight, from 0.6% to 1.5% by weight, from 0.6% to 1.2% by weight, or from 0.6% to 1% by weight.

In one embodiment, the organic molecule expander is present in the negative active material composition in an amount ranging from 0.1% to 1.5% by weight relative to the total weight of the composition, e.g., from 0.2% to 1.5% by weight, from 0.2% to 1% by weight, from 0.3% to 1.5% by weight, from 0.3% to 1% by weight, or from 0.3% to 0.8% by weight.

In one embodiment, both the carbonaceous material and the organic molecule expander is present in the negative active material composition in an amount ranging from 0.1% to 2% by weight relative to the total weight of the composition, e.g., from 0.1% to 1.5% by weight. In another embodiment, the carbonaceous material is present in an amount ranging from 0.2% to 1.5% by weight relative to the total weight of the composition, e.g., from 0.3% to 1.5% by weight, and the organic molecule expander is present in an amount ranging from 0.2% to 1.5% by weight, from 0.3% to 1.5% by weight, from 0.2% to 1% by weight, or from 0.3% to 1% by weight.

Another embodiment provides a method of making a negative active material. Typically, the carbonaceous material is initially combined with the expander and other components (e.g., BaSO₄) as a dry mixture. The subsequent addition of sulfuric acid to this dry mixture results in the formation of PbSO₄, hydrogen, and base, causing the expander to become immobilized at the Pb/PbSO₄/PbO surface. However, due to the presence of the carbonaceous material, and because expander is a good dispersant for carbon, the expander can adhere to form multilayers at the carbon surface, leaving a significantly smaller amount of expander available for the lead surface.

In one embodiment, it has been discovered that delaying the addition of the carbonaceous material to the organic molecule expander reduces the amount of expander adsorbed to the carbon surface and increases the available amount of expander for coating the lead-containing surface and countering the PbSO₄ passivating layer, thereby improving cold crank ability (increasing the cold crank time). Accordingly, one embodiment provides a method of making a negative active material comprises:

combining a lead oxide, an organic molecule expander, and BaSO₄ to form a dry powder mixture;

combining the dry powder mixture with water, to which sulfuric acid is subsequently added, to form a slurry;

adding to the slurry a carbonaceous material having a surface area of at least 250 m²/g, and

forming a paste intermediate of the negative active material composition.

In one embodiment, a lead oxide can be PbO or leady oxide, a mixture comprising primarily PbO and lead.

In one embodiment, the carbonaceous material been prewetted with water prior to the step of adding to the slurry. One skilled in the art can determine the amount of water needed for prewetting based on the amount of carbonaceous material added. In one embodiment, the ratio of carbonaceous material to water ranges from 1:1 to 1:3 by weight.

Another embodiment provides a method of making a negative active material composition for a lead acid battery, comprising:

combining a lead oxide, an organic molecule expander, and BaSO₄ to form a dry powder mixture;

adding a pre-wetted carbonaceous material having a surface area of at least 250 m²/g to the dry powder mixture;

combining sulfuric acid and water with the mixture containing the carbonaceous material to form a slurry; and

forming a paste intermediate of the negative active material composition.

In one embodiment, the step of combining sulfuric acid and water with the mixture containing the carbonaceous material can be performed in any order, e.g., water is added initially followed by the addition of sulfuric acid, or in reverse order, or the combining step comprises simultaneous addition of sulfuric acid and water to form a paste.

In one embodiment, the paste intermediate is dried. In one embodiment, the drying is achieved by a slow cure, such as under controlled humidity conditions and a moderate amount of heat (e.g., from 30 to 80° C. or from 35 to 60° C.) under controlled humidity, resulting in a porous solid. The curing step can then followed by a second heating step (drying) at an elevated temperature (e.g., from 50 to 140° C. or from 65 to 95° C.) at extremely low humidity, or even zero humidity. In one embodiment, the composition is a monolith. Other pasting, curing, and formation procedures are described in “Lead Acid Batteries,” Pavlov, Elsevier Publishing, 2011, the disclosure of which is incorporated herein by reference.

In one embodiment, the paste intermediate is deposited (pasted) onto a substrate, such as a grid and allowed to dry on the substrate to form the electrode. In one embodiment, the grid is a metallic structures that come in a myriad of designs and shapes (e.g., punched or expanded from sheets), functioning as the solid permanent support for the active material. The grid also conducts electricity or electrons to and away from the active material. Grids can comprise pure metals (e.g., Pb) or alloys thereof. The components of those alloys can comprise Sb, Sn, Ca, Ag, among other metals described in “Lead Acid Batteries,” Pavlov, Elsevier Publishing, 2011, the disclosure of which is incorporated herein by reference.

In this method, the organic molecule expander is allowed to combine with the lead oxide prior to the addition of the carbonaceous material, thereby promoting the formation of larger pore sizes during the drying of the paste.

It can be seen that the compositions and methods disclosed herein can increase pore size of the negative active material, resulting in improved battery performance (DCA, life cycle) while maintaining or even improving the cold crank ability compared to prior art lead acid batteries. In one embodiment, a battery comprising the negative active material disclosed herein exhibits a DCA increased by at least 30%, or at least 100% when compared with a battery incorporating carbon black having a surface area of 30 m²/g and 0.2% Vanisperse-A (“standard prior art battery”). In another embodiment, a battery comprising the negative active material disclosed herein exhibits a cycle life increased by at least 5×, or at least 6×, when compared with the standard prior art battery. Both these improvements can be achieved while maintaining the cold crank time to within 30% (or even improved over) the value of the standard prior art battery.

### EXAMPLES

### Examples 1-4

This Example describes the preparation of an NAM paste in which pre-wetted carbon black is added to a dry mixture of leady oxide, BaSO₄ and Vanisperse A.

Leady oxide (1000 g, 75% degree of oxidation, Barton oxide from Monbat PLC, Bulgaria) was introduced into the paste mixer. After 2 minutes of stirring, BaSO₄ (8 g) and Vanisperse A were added along with carbon black (PBX51®, Cabot Corporation) that was prewetted with water. The dry mixture was homogenized in the paste mixer via stirring for an additional 3 minutes followed by the addition of water (140 g). The paste was mixed for 5 minutes at which point H₂SO₄ (80 mL, specific density=1.4 g/cm³) was added and mixed for 15 minutes. More water can be added to adjust paste rheology; however, this was not needed for this example.

Table 1 below provides the amounts of Vanisperse and carbon black for each Example.

TABLE 1

| | Example 1 | Example 2 | Example 3 | Example 4 |
|---|---|---|---|---|
| Vanisperse A (g) | 2 | 2 | 4 | 6 |
| carbon black (g) | 5 | 10 | 10 | 10 |
| prewetted in | 11 | 22 | 22 | 22 |
| water (g) | | | | |

### Example 5

This Example describes an alternative method for the preparation of a NAM paste, where pre-wetted carbon black was added to the paste mix after the addition of sulfuric acid.

Leady oxide (1000 g, 75% degree of oxidation, Barton oxide from Monbat PLC, Bulgaria) was mixed alone in a paste mixer for 2 minutes to break up loose agglomerates. To this dry powder, lignosulfonate (2 g, Vanisperse A) and BaSO₄ (8 g) was added and mixed as a dry powder for an additional 3 minutes. Water (140 g) was then added and mixed for additional 5 minutes, followed by the addition of sulfuric acid (80 mL, specific density=1.4 g/cm³), and subsequent mixing for 15 minutes. Carbon black (10 g, PBX51®, Cabot Corporation, surface area of 1400 m2/g) was pre-wetted with water (22 g) and added to the mixture and mixed for 15 minutes. Additional water may be added to meet the desired consistency of the paste; however, in this case no additional water was needed.

### Example 6

This Example describes the preparation of an intermediate NAM paste.

Leady oxide (1000 g, 75% degree of oxidation, Barton oxide from Monbat PLC, Bulgaria) was mixed alone in a paste mixer for 2 minutes to break up loose agglomerates. To this dry powder, lignosulfonate (2 g, Vanisperse A) and BaSO₄ (8 g) was added and mixed as a dry powder for an additional 3 minutes. Water (140 g) was then added and mixed for additional 5 minutes, followed by the addition of sulfuric acid (80 mL, specific density=1.4 g/cm³), and subsequent mixing for 15 minutes. The product is an intermediate NAM paste to which carbon black can be added in desired amounts.

### Example 7

This Example describes the preparation of an electrode from an intermediate paste.

The NAM paste was deposited onto a lead grid and cured in a controlled atmosphere followed by drying. The dried electrode plate was electrochemically treated in the presence of sulfuric acid electrolyte, resulting in a formed Negative Active Material (NAM) containing 85-100% lead at the negative electrode.

### Example 8

This Example describes the configuration of 4.8 Ah lead acid test cells used for testing the cold crank times and water loss.

Testing was conducted in lead-acid cells with 2 negative and 3 positive plates with nominal capacity 4.8 Ah. The rated capacity of the cells was calculated at 50% utilization of the negative active material. AGM separators (H&V, USA) with a thickness of 3 mm (425 g m⁻²) were used under 20% compression. The electrolyte was a 1.28 g cm⁻³ H₂SO₄ solution.

### Example 9

The negative electrodes were prepared from the materials of Examples 1-6, manufactured by the method of Example 7 and assembled in cells as described in Example 8. Positive electrodes were identical in all cases and composed of 90-100% PbO.

Cold crank times were obtained at −18° C. via a modified version of Deutches Institut fur Normung or DIN test 43539 and are listed in Table 2 below. Specifically, the method was modified to go to a higher C rate of 10 C for 10 seconds followed by 6 C for the remainder of the test, whereas, the typical DIN 43539 is performed at 5 C. The results at 5 C showed a similar trend to the reported values in Table 2. It should be noted that these tests are on cells and not on full batteries, therefore, the voltages are reduced by a factor of 6. The initial voltage is 2.4 V (not 14.4 V) for cell and failure voltage is 1.0 V (vs. 6 V for full battery).

Water loss for the cells was tested by placing the cells from in a water bath at 60° C. and applying a constant voltage of 2.4V for 3 weeks. The water loss was measured by the difference in cell weight before the start of the test and after 3 weeks of overcharge at 2.4V (the corresponding overcharge voltage for a full battery is 14.4V). The weight loss (water loss) was normalized by the cells rated capacity in Ah, and presented in Table 2 in [g/Ah].

TABLE 2

| | | | Total | |
|---|---|---|---|---|
| | Voltage | Voltage | time | Water |
| | after | after | duration | loss |
| | 10 sec [V] | 40 sec [V] | [sec] | [g/Ah] |
| 0.5% PBX51P (Example 1) | 1.33 | 1.51 | 91 | 4.12 |
| 1.00% PBX51P VS-A at 0.2% | 1.28 | 1.45 | 71 | 7.78 |
| (Example 2) | | | | |
| 1.00% PBX51P + 0.4% VS- | 1.27 | 1.45 | 86 | 3.00 |
| A (Example 3) | | | | |
| 1.00% PBX51P + 0.6% VS- | 1.31 | 1.50 | 117 | 3.43 |
| A (Example 4) | | | | |
| 1.00% PBX51P | 1.39 | 1.55 | 102 | — |
| (Example 5) | | | | |
| 0% carbon (Example 6) | | | | 1.26 |

From the results of the cells tested with the NAM pastes of Examples 6 (0% carbon), Example 1 (0.5% carbon), and Example 2 (1% carbon), it can be seen that water loss increases as the carbon black loading increases. The material of Example 2 also yields the lowest cold crank time. However, the presence of additional organic molecule expander (Examples 3 and 4) resulted in reduced water loss, relative to Example 2, and increased cold crank time.

### Example 10

This Example describes the preparation of an NAM paste via a dry mix.

Leady oxide (1000 g, 75% degree of oxidation, Barton oxide from Monbat PLC, Bulgaria) was introduced into the paste mixer. After 2 minutes of stirring, BaSO₄ (8 g), Vanisperse A (2 g) and carbon black (10 g, PBX51®, Cabot Corporation) were added. The dry mixture was homogenized in the paste mixer via stirring for an additional 3 minutes followed by the addition of water (140 g). The paste was mixed for 5 minutes at which point H₂SO₄ (80 mL, specific density=1.4 g/cm³) was added slowly under continuous stirring. The temperature was maintained below 60° C. while stirring was continued for 15 minutes. More water can be added to adjust paste rheology; however, this was not needed for this example.

### Example 11

This Example describes the preparation of an NAM paste via the addition of a prewetted mixture of expander and carbon black.

Leady oxide (1000 g, 75% degree of oxidation, Barton oxide from Monbat PLC, Bulgaria) was introduced into the paste mixer. After 2 minutes of stirring, BaSO₄ (8 g) was added along with a mixture of Vanisperse A (2 g) and carbon black (10 g, PBX51®, Cabot Corporation) that was prewetted with water (22 g). The dry mixture was homogenized in the paste mixer via stirring for an additional 3 minutes followed by the addition of water (140 g). The paste was mixed for 5 minutes at which point H₂SO₄ (80 mL, specific density=1.4 g/cm³) was added and mixed for 15 minutes. More water can be added to adjust paste rheology; however, this was not needed for this example.

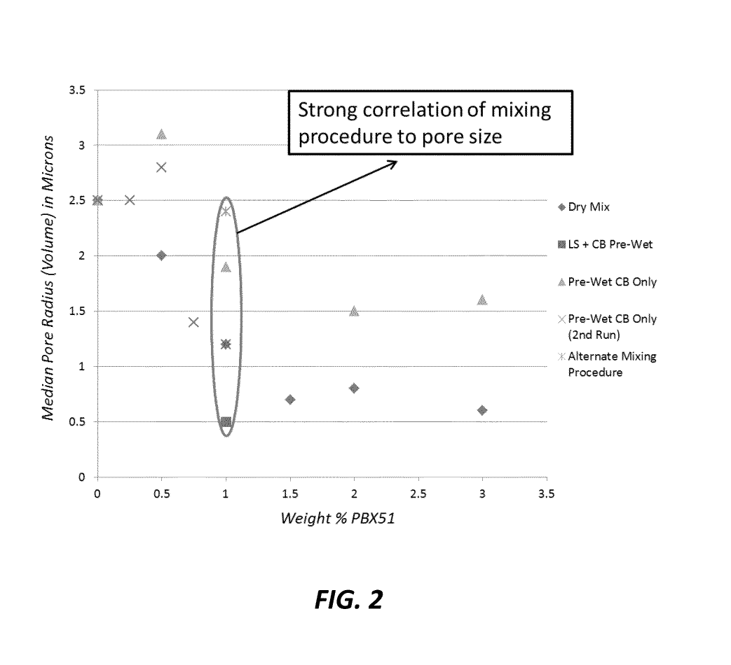

FIG. 2 is a graph depicting the correlation of mixing method of carbonaceous material with lignosulfonate and amount of carbonaceous material (x-axis, wt. %) with pore size (y-axis, median pore radius (volume, μm)) where: ♦ dry mix of lignosulfonate (LS)+PbO+carbon (Example 10); ▪ prewetted mix of LS+carbon (Example 11); ▴ prewetted carbon (Example 2); X prewetted carbon (2^{nd} run, Example 2); * lignosulfonate+PbO+H₂SO₄ followed by addition of prewetted carbon (Example 5). From FIG. 2, it can be seen that the disclosed methods in the disclosed amounts provides the largest median pore size.

The use of the terms “a” and “an” and “the” are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

1. A negative active material composition, comprising:
a carbonaceous material having a surface area of at least 250 m2/g; and
an organic molecule expander,
wherein the ratio of carbonaceous material to expander ranges from 5:1 to 1:1, and
wherein the composition has a median pore size ranging from 0.8 μm to 4 μm.

2. The composition of claim 1, wherein the carbonaceous material is selected from carbon black, activated carbon, expanded graphite, graphene, few layer graphene, carbon nanotubes, carbon fibers, carbon nanofibers, graphite.

3. The composition of claim 1, wherein the carbonaceous material has a surface area ranging from 400 m²/g to 1800 m²/g.

4-6. (canceled)

7. The composition of claim 1, wherein the carbonaceous material has a DBP ranging from 32 mL/100 g to 500 mL/100 g.

8. The composition of claim 1, wherein the organic molecule expander is selected from lignosulfonates, lignins, wood flour, pulp, humic acid, wood products, and derivatives and decomposition products thereof.

9. The composition of claim 1, wherein the organic molecule expander is selected from lignosulfonates.

10. The composition of claim 1, further comprising a lead-containing material and BaSO₄.

11. The composition of claim 10, wherein the lead-containing material is selected from lead, PbO, Pb₃O₄, Pb₂O, and PbSO₄, and hydroxides, acids, and other metal complexes thereof.

12. The composition of claim 10, wherein the lead-containing material comprises lead and at least 20% of the organic molecule expander coats a surface of the lead-containing material.

13. (canceled)

14. The composition of claim 1, wherein the composition has a surface area greater than 3.0 m²/g.

15. The composition of claim 1, wherein the composition has a median pore size ranging from 1.0 μm to 3.5 μm.

16-20. (canceled)

21. The composition of claim 1, wherein the organic molecule expander is present in an amount ranging from 0.1% to 1.5% by weight, relative to the total weight of the composition.

22. (canceled)

23. The composition of claim 1, wherein the organic molecule expander is present in an amount ranging from 0.3% to 1.5% by weight, relative to the total weight of the composition.

24. The composition of claim 1, wherein the carbonaceous material is present in an amount ranging from 0.05% to 3% by weight.

25. The composition of claim 1, wherein the carbonaceous material is present in an amount ranging from 0.15% to 2% by weight.

26-27. (canceled)

28. The composition of claim 1, wherein the composition is a monolith.

29. An electrode comprising the negative active material composition of claim 1.

30. (canceled)

31. A lead acid battery comprising the electrode of claim 29.

32. The battery of claim 31, wherein the battery exhibits a dynamic charge acceptance value increased by at least 30% when compared with a standard battery incorporating carbon black having a surface area of 30 m²/g and 0.2% Vanisperse-A, without a reduction in cold crank time by more than 30% that of the standard battery.

33. The battery of claim 31, wherein the battery exhibits a life cycle increased by at least 5× when compared with a battery incorporating carbon black having a surface area of 30 m²/g and 0.2% Vanisperse-A, without a reduction in cold crank time by more than 30% that of the standard battery.

34. A method of making a negative active material composition for a lead acid battery, comprising:
combining a lead oxide, an organic molecule expander, and BaSO₄ to form a dry powder mixture;
combining the dry powder mixture with water, to which sulfuric acid is subsequently added, to form a slurry; and
adding to the slurry a carbonaceous material having a surface area of at least 250 m²/g, and
forming a paste intermediate of the negative active material composition.

35. The method of claim 34, wherein the carbonaceous material has been prewetted with water prior to the adding.

36. A method of making a negative active material composition for a lead acid battery, comprising:
combining a lead oxide, an organic molecule expander, and BaSO₄ to form a dry powder mixture;
adding a pre-wetted carbonaceous material having a surface area of at least 250 m²/g to the dry powder mixture;
combining sulfuric acid and water with the mixture containing the carbonaceous material to form a slurry; and
forming a paste intermediate of the negative active material composition.

37. The method of claim 36, further comprising drying the paste intermediate to form a solid negative active material composition.

38. The method of claim 37, wherein the drying comprises curing the paste at a temperature ranging from 30 to 80° C., followed by a second heating step at an elevated temperature ranging from 50 to 140° C.

39. The method of claim 36, further comprising depositing the paste intermediate onto a substrate and drying the paste intermediate to form a solid negative active material composition.

40-43. (canceled)

44. A negative active material composition prepared by the method of claim 36.

45. (canceled)

46. A negative active material composition prepared by the method of claim 34.
